(19) United States
(12) Patent Application Publication
(10) Pub. No.: US 2002/0147702 A1
(43) Pub. Date: Oct. 10, 2002

(54) Self-service terminals and self-service networks

(75) Inventor: Paul Nielsen, St. Andrews (GB)

Correspondence Address: MICHAEL CHAN, NCR CORPORATION, 1700 SOUTH PATTERSON BLVD, DAYTON, OH, 45479-0001, US

(73) Assignee: NCR Corporation

(21) Appl. No.: 10/101,581

(22) Filed: Mar. 20, 2002

(30) Foreign Application Priority Data
Apr. 5, 2001 (GB) 0108542.2

(51) Int. Cl. G06F 7/00

(52) U.S. Cl. 707/1

(57) ABSTRACT

An ATM network is coupled to a data warehouse. Information about usage and operation of ATMs such as transactions, the timing of transactions and ATM locations stored in the data warehouse. Complex queries performed on the data warehouse are then used to provide information about trends in the network.

### BACKGROUND OF THE INVENTION

This invention relates to methods of analyzing a self-service network, to a data warehouse, to a self-service terminal and to a method of generating revenue.

Presently, a small number of organizations collect information from ATM deployers about their ATM fleets, aggregate it and produce anonymized reports outlining trends and statistics in the use of self-service ATM terminals. However, this type of report is prepared manually and thus there is a time lapse of weeks or months between data gathering and report finalization and furthermore, there is no possibility of re-defining the way the report is presented such as by performing personalized queries on the data. For example, the reports are prepared based on a plurality of deployer's ATM fleets and do not relate to a particular fleet. Thus it is not possible to isolate the effect of changes made in the operation of a particular fleet. This is a significant handicap if, for example, an operator has unilaterally made a change to gain a competitive advantage or to solve a problem since the effect of the change cannot readily be assessed.

### SUMMARY OF THE INVENTION

An object of the invention is therefore to provide a tool offering a more refined or sophisticated level of analysis of operational characteristics of self-service networks and preferably in real-time or near real-time.

In accordance with the invention there is provided a method of analyzing a plurality of self-service terminals in a distributed network of terminals comprising arranging for at least one of the terminals to record data related to operations carried out by the terminal, communicating with a terminal to collect the recorded data, storing the collected data in a data warehouse, and performing a real-time or near real-time analysis of the network by performing a query on the collected data using the data warehouse.

Preferably, the plurality of terminals is distributed across more than one deployer network. The data is preferably collected and stored in real time as this allows queries to be produced on up to date data.

It will be appreciated that in order to optimize communication costs, a terminal may not have a “permanently on” connection to the network. For example, the connection to the network may be achieved using a dial up cellular telephone connection. Such a connection is periodically initiated and data uploaded or downloaded as required. Thus, the term “real time” encompasses such a situation in which the data is stored and collected in “near real time” i.e. possibly with a lag of a few hours.

According to a second aspect, there is provided a data warehouse operable to receive data from a network of self service terminals comprising a data store operable to hold operational data which characterizes operations carried out by a terminal in the network, and a data processor operable to process data in the data store to provide information in real time or near real time related to one or more of the plurality of self-service terminals.

According to a third aspect there is provided a self service terminal including network connection means for coupling the terminal to a self-service network, the terminal being arranged to return information to the network in real-time or near real-time, which characterizes operations carried out at the terminal, and the network including a dataware-house arranged to perform a real-time or near real-time analysis of the network by performing a query on the returned data.

According to a method aspect, there is provided a method of analyzing a self service terminal network comprising the steps of providing database means operable to hold data related to transactions performed by a terminal in the network, gathering terminal data from terminals in the network which is related to operations performed by each terminal in the network, entering the terminal data into the database means, and analyzing the terminal network by querying the data in the database means to produce a database report which reflects operational characteristics of the network in real-time or near real-time.

According to a further method aspect, there is provided a method of generating revenue comprising gathering data from a plurality of self-service terminals forming a network, producing a database by storing the data in a data warehouse, making an agreement with a report receiver specifying a predetermined database query, a price structure for the report and a report delivery format, querying the database to produce a predetermined database report which complies with the agreement, delivering the report to the report receiver in real-time or near real-time, and receiving payment for the report.

According to yet a further method aspect, there is provided a method of producing a report for analyzing a network of self-service terminals comprising gathering data from a plurality of self-service terminals forming the network, producing a database by storing the data in a data warehouse, and querying the database to produce a predetermined database report which reflects operational characteristics of the network in real-time or near real-time.

The term “self-service apparatus” is used herein to refer to unattended apparatus which may receive user input and/or provide information to a user, for example about a bank account. Such self-service apparatus (or terminal) may also be arranged to allow a user to initiate and/or complete transactions such as purchasing items or withdrawing money from a bank account, whilst being unattended by anyone other than the user. Examples of self-service apparatus include automated teller machines (ATM), vending machines and non-cash kiosks with touch screen displays. Another example is a web-enabled, interactive display forming an integral part of a fuel dispensing pump in an automotive fuel station.

The term “deployer” is used herein to refer to an owner or controller of a plurality (fleet) of self-service terminals.

Actions or processes that are initiated and completed instantaneously after the occurrence of one or more trigger events are said to be completed in “real time”. For example, many ATMs in current usage operate to update bank account details using on-line transaction processing (OLTP) which is substantially real time. In contrast, batch processing, which often involves manual input of data into a computer system, for example, at the end of each working day, is not “real time”. In batch processing, trigger events such as bank account transactions occur during the working day, but actions or processes to log these transactions in a central computer system only occur once a plurality of trigger events have accumulated. For example, this may be at the end of each day. An advantage of this is that processing a batch of items is often more computationally efficient and the processing can take place at “non-busy” times. A continuum can then be thought of with batch processing at one end of the continuum and real time processing at the other end of the continuum. The term “near real time” is used to refer to processing that is not strictly real time, but which is closer to the real time end of the continuum than the batch processing end of the continuum.

The term “kiosk” is used herein to refer to a type of self-service apparatus which does not operate using cash.

The term “data warehouse” is used to refer to a storage means which is able to store data in such a manner that it is easily and quickly accessible in real time. A data warehouse is also operable to perform complex pattern analysis of the data.

### BRIEF DESCRIPTION OF THE DRAWINGS

The invention will now be described by way of example with reference to the drawings in which:

FIG. 1 is a schematic diagram of a conventional ATM network containing two ATM deployer fleets;

FIG. 2 is a schematic block diagram of an ATM network coupled to a data warehouse;

FIG. 3 is a flow chart showing the use of the data warehouse in accordance with the invention;

FIG. 4 is a flow chart showing the operation of an ATM in accordance with the invention; and

FIG. 5 is a flow chart showing operation of an ATM in a further preferred embodiment of the invention.

### DETAILED DESCRIPTION

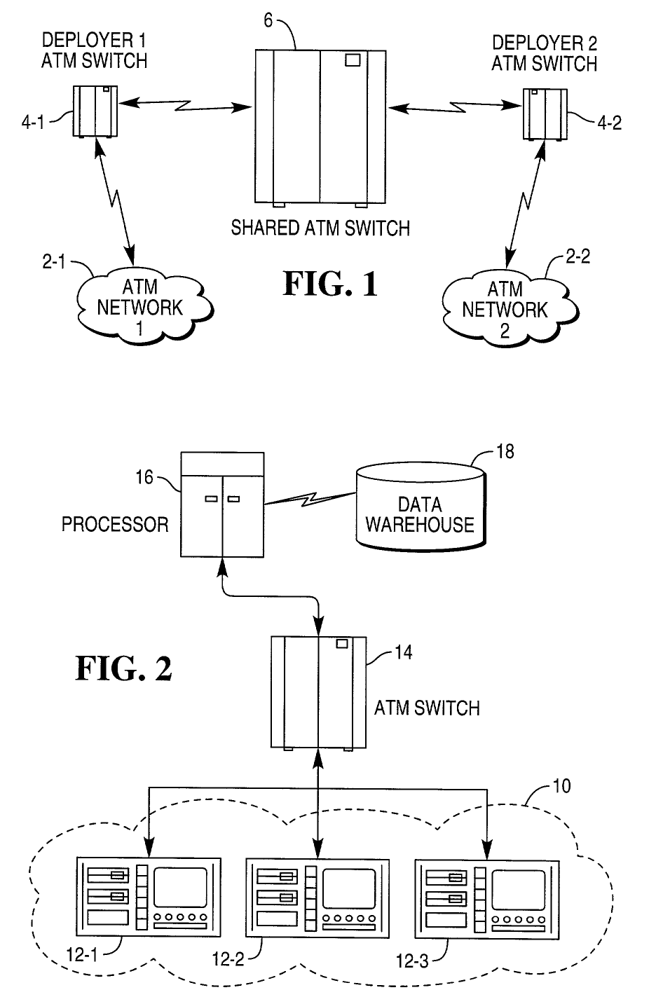

With reference to FIG. 1, a first ATM network 2-1 comprises a plurality of ATMs (not shown) communicatively coupled to a first ATM switch 4-1.

The network 2-1 is associated with a first deployer which may, for example, be a particular issuer bank.

Similarly, a second deployer has an ATM network 2-2 communicatively coupled to a second ATM switch 4-2. The two switches 4-1 and 4-2 are interconnected via a shared ATM switch 6. Thus, a customer of deployer 1 can use the second ATM network 2-2 since transaction requests are passed via deployer two ATM switch 4-2 and shared ATM switch 6 to the customer's own ATM network 2-1. It will be appreciated that the network represented in this figure is much simplified. In practice there are likely to be many shared switches, deployer switches and/or deployer networks.

The arrangement of FIG. 1 allows transactions to be processed successfully between different deployer fleets. However, this arrangement does not make it easy to make decisions concerning or assess the impact of the operational characteristics such as kiosk location, charging structure, advertising materials, time of day, the prevailing weather, day of the week, of the ATM terminals within the networks 2-1 and 2-2.

To overcome this, in the present invention the general structure of FIG. 2 is used. An ATM network 10 (which may be from a single deployer or typically from a plurality of deployers), contains ATM terminals 12-1, 12-2 and 12-3. These are coupled via an ATM switch 14 (which may designate a single deployer ATM switch such as 4-1 or 4-2 above or the combined effect of individual deployers ATM switches coupled via a shared ATM switch such as the switch 6), to a processor 16 operable to process information stored in a data warehouse 18.

The data warehouse 18 may for example be a NCR Teradata (trade mark) data warehouse which allows large volumes of data to be stored and for complex queries to be executed. It will be appreciated that the data warehouse 18 may physically be a plurality of distributed databases which typically would be logically associated into one or more data warehouse.

The configuration of FIG. 2 allows information about the use of the ATM terminals to be provided to deployers considerably more rapidly than the manual survey techniques used in the prior art. Furthermore, depending on the commercial relationship between a deployer and the data warehouse operator, a deployer may choose which analyses are performed on the ATM terminals in the network 10.

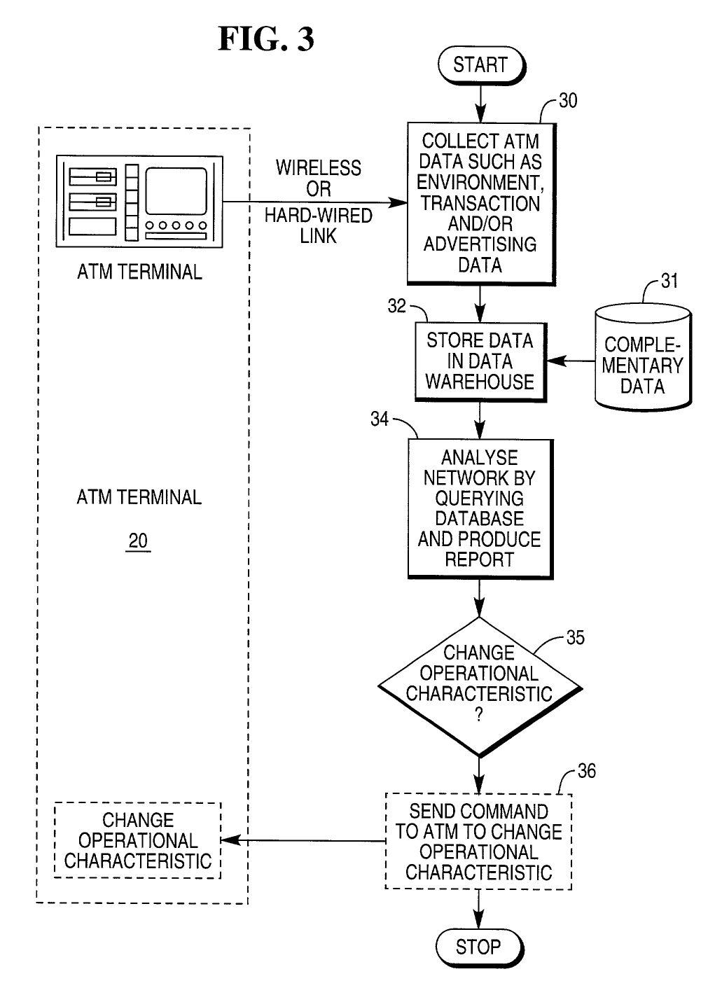

For example, with reference to FIG. 3, an ATM terminal 20 is configured to provide information about its operation to the processor 16 via the ATM switch 14. The processor 16 collects information from the ATM terminal (step 30). The information may for example be environment information such as the location of the ATM and the nature of businesses near to the ATM location. In an alternative embodiment, this environment information may be obtained from a separate static database 31 rather than being stored in the ATM and accessed via the ATM network. Such a database may include, for example, weather forecasts sourced from a third party such as a local meteorological office.

The ATM information typically includes transaction information such as the types of transactions and times of transactions carried out at the ATM since information was last collected.

This data is then stored in the data warehouse 18 (step 32). Complementary data such as weather patterns may also be added to the data warehouse. The database in the data warehouse is then queried (step 34) to provide information to generate predetermined reports which have been requested by bodies such as a self-service fleet operator (step 35). Because the database is implemented in a data warehousing system, such as a Teradata (Trade Mark) warehousing system, complex and far-reaching queries can be used to analyze the information in the database. These queries are typically carried out in a standard database query language, such as the Structured Query Language (SQL), put forth by ANSI (the American National Standards Institute).

One example of the type of query that might be run is one that searches for all ATM terminals in the network that are within a selected distance of a certain venue (e.g., a sports arena) and that tend to experience a certain amount of traffic within 30 minutes of the typical start-time for events at that venue. For any ATM that meets the search criteria, the network administrator (typically associated with a network deployer) might use the report to assess whether there are insufficient terminals in the area and might for example speed transaction processing by streamlining the operation of the terminal user interface for the duration of peak usage.

Another example of the type of query that might be run is one that discerns, for an ATM terminal at a branch location of a bank, what percentage of ATM customers use the bank's investment-brokerage services. If the percentage of brokerage customers exceeds some minimum value (perhaps indicating wealth in the surrounding community), the administrator might instruct the ATM terminal to offer those services at a higher menu level. A subsequent query might be used to determine how many of those customers later established a brokerage account with the bank and thus to conclude how successful the operational change has been.

Optionally therefore, the processor 16 may initiate a charge in the operation of the terminal (step 36).

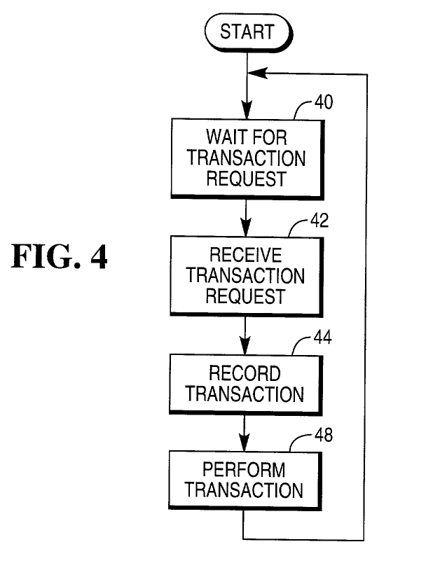

With reference to FIG. 4, an ATM terminal waits for a transaction request (step 40).

A transaction request is received (step 42) and recorded (step 44) and the transaction is then performed (step 48). The ATM loops back to wait for another transaction.

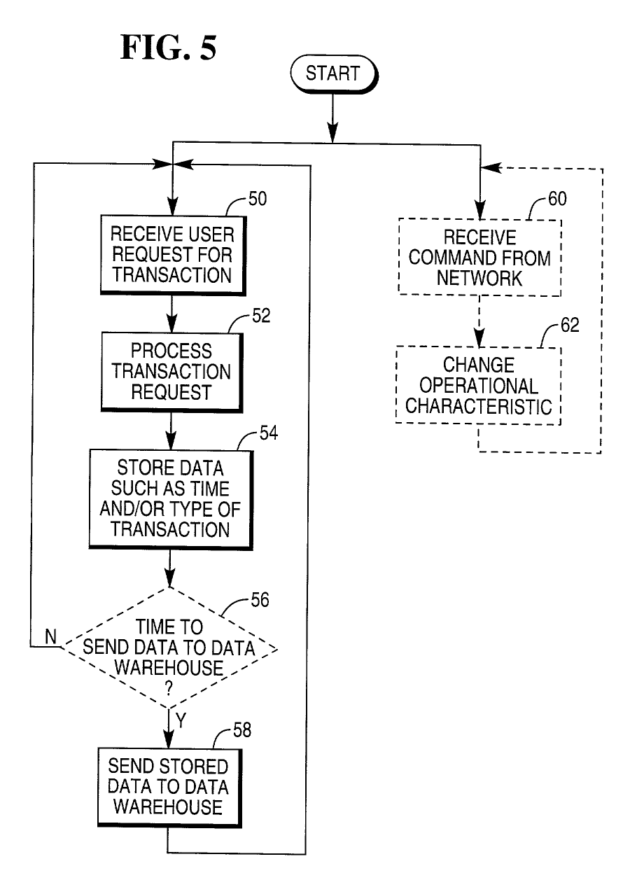

FIG. 5 shows the data gathering/collecting steps which are typically performed by an ATM terminal.

In step 50 the ATM receives a user request for a transaction. The ATM processes the transaction request (step 52) and then stores internally, data such as the time and/or type of transaction during and/or after the transaction is initiated (step 54).

In optional step 56, the terminal determines whether it is due to make a periodic dialup connection to the processor 16 in order to upload the stored transaction information generated in step 54. This step is optional, because some ATMs may be permanently connected to the processor 16 in which case the ATM proceeds immediately to step 58 to send the stored dated to the data warehouse 18 via the processor 16. A connection may alternatively be initiated by the processor 16. This process thereby provides the information collected in step 30 of FIG. 3.

Also, the ATM optionally receives commands from the ATM network issued by the processor 16 (step 60) to adjust particular operational characteristics (step 62). It will be appreciated that the command received in step 60 is that issued in step 36 of FIG. 3.

Thus the configuration and processes explained in detail above, allow an ATM deployer to provide detailed information about the operation of the fleet of ATMs under its control. This information may then be used to analyze that fleet and/or be aggregated with that from other fleets to analyze general trends in self-service terminal networks.

This will become increasingly important as the menu of possible transactions which can be performed by an ATM terminal increases. New transactions will bring new usage patterns which in turn, will provide opportunities for changes in operation. The invention described above allows the impact of these new types of operation and the new types of usage patterns to be carefully analyzed in order not to confuse or upset customers and also in order to ensure that terminal operational characteristics are optimized.

Thus in summary, various organizations such as retail banking research in the UK and Mentis/Gartner, Meridian and Dove Associates in the US already provide a service to self-service network deployers by collecting information from such deployers about their ATM fleets. The information is aggregated and used to produce anonymized reports showing self-service trends and statistics. The business model of providing these reports is well established and is successful. The model demonstrates that deployers are comfortable pooling self-service data with a trusted intermediary. However, the mechanisms used to collect the data mean that the trends are out of date by weeks or even months when the reports are issued and also a report receiver has little or no control over the nature of the reports and therefore the analyses which are performed on the information or data.

The present invention has the ability to provide real-time or near real-time performance rather than cycles of months which the existing systems necessarily entail. It also offers more choice in information sharing since deployers may strike bilateral and multilateral agreements with each other to share data rather than being required to have a uniform level of aggregation and sharing as presently exists. The use of a data warehouse mechanism allows state of the art reporting querying and data mining capabilities to be executed on the data and the nature of the queries may be customized for each deployer thereby replacing static generic reports presently available. Furthermore, the data warehouse mechanism allows complementary data such as weather patterns to be included in the information so that deployers may for example analyze or normalize for trends caused by weather patterns.

What is claimed is:

1. A method of analyzing a plurality of self-service terminals in a distributed network of terminals comprising the steps of:
(a) arranging for at least one of the terminals to record data related to operations carried out by the terminal;
(b) communicating with a terminal to collect recorded data;
(c) storing collected data in a data warehouse; and
(d) performing a real-time or near real-time analysis of the network by performing a query on collected data using the data warehouse.

2. A method according to claim 1, wherein the plurality of terminals are distributed across more than one deployer network.

3. A method according to claim 2, further comprising the step of providing a shared ATM switch which interconnects one deployer network with another deployer network.

4. A method according to claim 1, wherein the communicating step is carried out to collect the data in real-time or near real-time.

5. A data warehouse operable to receive data from a network of self-service terminals comprising:
a data store operable to hold operational data which characterizes operations carried out by a terminal in the network; and
a data processor operable to process data in the data store to provide information in real-time or near real-time related to one or more of the plurality of self-service terminals.

6. A self-service terminal comprising:
network connection means for coupling the terminal to a self-service network which has a data-warehouse arranged to perform a real-time or near real-time analysis of the network by performing a query on returned data associated with the terminal; and
means for returning data to the network in real-time or near real-time, which data characterizes operations carried out at the terminal.

7. A method of analyzing a self-service network comprising the steps of:
gathering terminal data from terminals in the network, which data is related to operations performed by each terminal in the network;
entering the terminal data into a database system for holding data related to transactions performed by a terminal in the network; and
analyzing the terminal network by querying the data in the database system to produce a database report which reflects operational characteristics of the network in real-time or near real-time.

8. A method of generating revenue comprising:
(a) gathering data from a plurality of self-service terminals forming a network;
(b) producing a database by storing data in a data warehouse;
(c) making an agreement with a report receiver specifying a predetermined database query, a price structure for the report, and a report delivery format;
(d) querying the database to produce a predetermined database report which complies with the agreement;
(e) delivering the report to the report receiver in real-time or near real-time; and
(f) receiving payment for the report.

9. A method according to claim 8, further comprising:
making a plurality of agreements with respective self-service fleet deployers each operating a distinct network of self-service terminals;
gathering data from self-service terminals distributed across more than one of the networks; and
storing data in the data warehouse to produce a database reflecting operational characteristics of more than one of the networks.

10. A method of producing a report for analyzing a network of self-service terminals comprising:
(a) gathering data from a plurality of self-service terminals forming the network;
(b) producing a database by storing the data in a data warehouse; and
(c) querying the database to produce a predetermined database report which reflects operational characteristics of the network in real-time or near real-time.
